(19) United States
(12) Patent Application Publication
(10) Pub. No.: US 2018/0127558 A1
(43) Pub. Date: May 10, 2018

(54) FIBER-REINFORCED THERMOPLASTIC RESIN COMPOSITION

(71) Applicant: MITSUBISHI GAS CHEMICAL COMPANY, INC., Tokyo (JP)

(72) Inventors: Takahiro MATSUMOTO, Chiba (JP); Fumiaki KAKEYA, Saitama (JP); Yasutaka FUKUNAGA, Tokyo (JP); Aki KATORI, Niigata (JP)

(73) Assignee: MITSUBISHI GAS CHEMICAL COMPANY, INC., Tokyo (JP)

(21) Appl. No.: 15/566,051

(22) PCT Filed: Apr. 14, 2016
(86) PCT No.: PCT/JP2016/061962

§ 371 Date: Oct. 12, 2017

(30) Foreign Application Priority Data
Apr. 21, 2015 (JP) 2015-086990

(51) Int. Cl. C08J 5/24

(52) U.S. Cl. CPC C08J 5/24; C08J 2325/12

(57) ABSTRACT

The present invention provides a fiber-reinforced thermoplastic resin composition containing a continuous reinforcing fiber and a thermoplastic resin, wherein the thermoplastic resin includes a copolymer of a cyano group-containing vinyl monomer and an aromatic vinyl monomer, wherein the amount of a conjugated diene component in the copolymer (100% by mass) is 10% by mass or less.

### FIELD OF THE INVENTION

The present invention relates to a fiber-reinforced thermoplastic resin composition which is advantageously used in, for example, aircraft members, aerospace plane members, automobile members, vessel members, construction and civil engineering materials, electronic device members, and sporting goods members.

### BACKGROUND ART

Carbon fibers, glass fibers, and aramid fibers, which are low in specific gravity as compared to metals, have excellent modulus and excellent strength, and composite materials comprising a combination of these fibers and various matrix resins have been used in many fields, such as aircraft members, aerospace plane members, automobile members, vessel members, construction and civil engineering materials, electronic device members, and sporting goods. Particularly, a thermosetting carbon fiber-reinforced composite material comprising a combination of a carbon fiber and a thermosetting resin, such as an epoxy resin or an unsaturated polyester resin, has been widely used.

The conventional thermosetting carbon fiber-reinforced composite material has a disadvantage in that heat-curing of the material requires a great amount of time. For removing such a disadvantage, in recent years, a carbon fiber-reinforced thermoplastic composite material (hereinafter, frequently referred to as “CFRTP”) using a thermoplastic resin as a matrix is expected as a composite material which can be high-cycle molded, and the development of this composite material is being made.

A short fiber-reinforced thermoplastic composite material which can be molded into a complicated shape has already been put into practical use, but poses a problem in that the fiber length of the reinforcing fiber used in the composite material is short and hence the composite material has an extremely low modulus, as compared to a light metal. For this reason, a thermoplastic resin composition reinforced with a continuous fiber is strongly desired.

As a matrix resin used in the CFRTP, inexpensive general-purpose plastics, for example, polypropylene (PP) and acrylonitrile-butadiene-styrene (ABS) are expected. However, a composite material of such a thermoplastic resin and, particularly, a carbon fiber is not satisfactory in mechanical properties, especially in flexural strength.

For the purpose of improving the mechanical properties, a proposal has been made in which a carbon fiber is subjected to oxidation treatment, such as gaseous phase oxidation or liquid phase oxidation, to introduce an oxygen-containing functional group to the surface of the carbon fiber, improving the interfacial adhesion of the carbon fiber to the matrix resin.

For example, patent document 1 has proposed a method in which a carbon fiber is subjected to electrolytic treatment to improve the interlaminar shear strength which is an index of the interfacial adhesion. However, the thermoplastic resin composite material reinforced with the treated carbon fiber is not satisfactory in mechanical properties.

Further, the carbon fiber itself has problems in that the fiber is brittle and has poor sizing properties and abrasion resistance, and further is likely to cause fuzzing or fiber breakage in the multiple-stage processing steps. In order to solve the problems of carbon fiber, patent documents 2 and 3 have proposed a method in which a sizing agent is applied to a carbon fiber. By applying a sizing agent to the carbon fiber, it is possible to impart to the carbon fiber satisfactory adhesion to a thermosetting resin; however, the interfacial adhesion of the resultant carbon fiber to a thermoplastic resin is still low, and further the thermoplastic resin composite material reinforced with the sizing-treated reinforcing fiber is not satisfactory in mechanical properties.

As mentioned above, for improving the composite material in mechanical properties, such as a flexural strength, treating only the carbon fiber is not satisfactory, and the existing techniques cannot achieve a thermoplastic carbon fiber composite material having a satisfactory flexural strength.

### PRIOR ART REFERENCES

### Patent Documents

Patent document 1: Japanese Unexamined Patent Publication No. Hei 04-361619

Patent document 2: U.S. Pat. No. 3,957,716 specification

Patent document 3: Japanese Examined Patent Publication No. Sho 62-056266

### SUMMARY OF THE INVENTION

### Problems to be Solved by the Invention

In view of the problems accompanying the above-mentioned prior art techniques, an object of the present invention is to provide a fiber-reinforced thermoplastic resin composition having excellent mechanical properties.

### Means for Solving the Problems

The present inventors have found that the above object can be achieved by a fiber-reinforced thermoplastic resin composition containing a continuous reinforcing fiber and a thermoplastic resin, wherein the thermoplastic resin comprises a copolymer of a cyano group-containing vinyl monomer and an aromatic vinyl monomer, wherein the amount of the conjugated diene component contained is a predetermined amount or less.

Specifically, the present invention is as shown below.

[1] A fiber-reinforced thermoplastic resin composition containing (A) a continuous reinforcing fiber and (B) a thermoplastic resin, wherein the thermoplastic resin (B) comprises (C) a copolymer of (c1) a cyano group-containing vinyl monomer and (c2) an aromatic vinyl monomer, wherein the amount of a conjugated diene component in the copolymer (C) (100% by mass) is 10% by mass or less.

[2] The fiber-reinforced thermoplastic resin composition according to item [1] above, wherein the continuous reinforcing fiber (A) is contained in an amount of 1 to 80% by mass and the thermoplastic resin (B) is contained in an amount of 20 to 99% by mass, based on the mass of the fiber-reinforced thermoplastic resin composition (100% by mass).

[3] The fiber-reinforced thermoplastic resin composition according to item [1] or [2] above, wherein the continuous reinforcing fiber (A) has an average fiber length of 10 mm or more.

[4] The fiber-reinforced thermoplastic resin composition according to any one of items [1] to [3] above, wherein the continuous reinforcing fiber contains any one selected from the group consisting of a carbon fiber, a glass fiber, and an aramid fiber.

[5] The fiber-reinforced thermoplastic resin composition according to any one of items [1] to [4] above, wherein the amount of the copolymer (C) in the thermoplastic resin (B) (100% by mass) is 50 to 100% by mass.

[6] The fiber-reinforced thermoplastic resin composition according to any one of items [1] to [5] above, wherein the amount of the cyano group-containing vinyl monomer (c1) in the copolymer (C) (100% by mass) is 15 to 45% by mass and the amount of the aromatic vinyl monomer (c2) in the copolymer (C) (100% by mass) is 55 to 85% by mass.

[7] The fiber-reinforced thermoplastic resin composition according to any one of items [1] to [6] above, wherein the copolymer (C) is a copolymer consisting of the cyano group-containing vinyl monomer (c1) and aromatic vinyl monomer (c2).

[8] The fiber-reinforced thermoplastic resin composition according to any one of items [1] to [7] above, wherein the copolymer (C) is acrylonitrile-styrene.

[9] A shaped article using the fiber-reinforced thermoplastic resin composition according to any one of items [1] to [8] above.

[10] The shaped article according to item [9] above, which has a maximum flexural strength of 300 MPa or more.

### Effects of the Invention

By an effect of improving the flexural strength of a composite material due to a cyano group and a reinforcing effect due to a continuous fiber, a fiber-reinforced thermoplastic resin composition having excellent mechanical properties can be obtained.

### MODE FOR CARRYING OUT THE INVENTION

The fiber-reinforced thermoplastic resin composition of the present invention is a fiber-reinforced thermoplastic resin composition containing a continuous reinforcing fiber and a thermoplastic resin, wherein the thermoplastic resin comprises a copolymer of a cyano group-containing vinyl monomer and an aromatic vinyl monomer.

<Continuous Reinforcing Fiber (A)>

Examples of the continuous reinforcing fibers (A) used in the present invention include a glass fiber, a carbon fiber (e.g., a PAN carbon fiber and a pitch carbon fiber), and an aramid fiber, and, from the viewpoint of the modulus, a carbon fiber is preferred.

It is preferred that the continuous reinforcing fiber (A) has an average fiber length of 10 mm or more, and it is more preferred that a fiber longer than that in a shaped article obtained after molded is used.

Examples of forms of the continuous reinforcing fiber include a unidirectional sheet, a woven sheet, and a multi-axial laminated sheet, and specific examples of the forms are shown below, but the present invention is not limited to these examples.

Glass fiber: WF 350 100 BS6 (manufactured by Nitto Boseki Co., Ltd.)

Aramid fiber: Towaron (manufactured by Teijin Limited)
Carbon fiber: CFP3113 (manufactured by Arisawa Mfg. Co., Ltd.)

The amount of the continuous reinforcing fiber (A) in the present invention may be 1 to 80% by mass, based on the mass of the fiber-reinforced thermoplastic resin composition (100% by mass), and, from the viewpoint of the mechanical properties of the fiber-reinforced thermoplastic resin composition, the amount is preferably 40 to 75% by mass, more preferably 50 to 75% by mass.

<Thermoplastic Resin (B)>

The thermoplastic resin (B) used in the present invention comprises a copolymer (C) of a cyano group-containing vinyl monomer (c1) and an aromatic vinyl monomer (c2). The copolymer (C) of the cyano group-containing vinyl monomer (c1) and the aromatic vinyl monomer (c2) means a copolymer formed from a monomer mixture comprising the monomer (c1) and the monomer (c2), and the arrangement of the monomers is not particularly limited and may be arrangement for, for example, a random, block, graft, or alternating copolymer.

The cyano group-containing vinyl monomer (c1) means a vinyl monomer having a cyano group, and, for example, there can be mentioned acrylonitrile and methacrylonitrile. From the viewpoint of the mechanical properties, acrylonitrile is preferred.

The amount of the cyano group-containing vinyl monomer (c1) in the copolymer (C) (100% by mass) may be 15 to 45% by mass, and is preferably 20 to 40% by mass for the reasons of mechanical properties. That is, the amount of the cyano group-containing vinyl monomer (c1) to the total amount of monomer components in the monomer mixture forming the copolymer (C) may be 15 to 45% by mass, and is preferably 20 to 40% by mass.

The aromatic vinyl monomer (c2) means a vinyl monomer having an aromatic ring, and, for example, there can be mentioned styrene, bromostyrene, and α-methylstyrene. From the viewpoint of easy availability, styrene is preferred.

The amount of the aromatic vinyl monomer (c2) in the copolymer (C) (100% by mass) may be 55 to 85% by mass, and is preferably 60 to 80% by mass from the viewpoint of the mechanical properties. That is, the amount of the aromatic vinyl monomer (c2) to the total amount of monomer components in the monomer mixture forming the copolymer (C) may be 55 to 85% by mass, and is preferably 60 to 80% by mass.

The monomer mixture forming the copolymer (C) may contain an arbitrary vinyl monomer. Examples of such vinyl monomers include ethylene-propylene-diene, acrylates, and 2-chloroethyl vinyl ether. Preferably, copolymer (C) is a copolymer formed only from the cyano group-containing vinyl monomer (c1) and the aromatic vinyl monomer (c2).

Examples of such copolymers (C) include an acrylonitrile-styrene (AS) resin, an acrylonitrile-ethylene-propylene-diene-styrene (AES) resin, and an acrylate-styrene-acrylonitrile (ASA) resin.

More specifically, there can be mentioned so-called AS resins or SAN resins, such as LITAC-A 100PCF/120PCF, manufactured by Nippon A&L Inc.; SANREX SAN-C/SAN-R/SAN-H/SAN-L/SAN-T, manufactured by Techno Polymer Co., Ltd.; Cevian-N 020/020SF/050/050SF/070SF/080SF, manufactured by Daicel Polymer Ltd.; STYLAC AS 767/T8701/769/789/783/T8707/CS747, manufactured by Asahi Kasei Chemicals Corporation; and Toyolac A20C-300/A25C-300, manufactured by Toray Industries Inc., and products of these resins are easily commercially available. The copolymer is not limited to these resins as long as the effects of the invention can be obtained.

The amount of the above-mentioned copolymer (C) in thermoplastic resin (B) (100% by mass) may be 50 to 100% by mass, and is preferably 80 to 100% by mass because an inexpensive composite material can be obtained.

The thermoplastic resin (B) may contain a component other than the above-mentioned copolymer (C) as long as the effects of the invention can be obtained, and various additives, such as the other resins, a release agent, a flame retardant, and an antioxidant, can be incorporated into the thermoplastic resin.

For example, the thermoplastic resin (B) can be used in the form of an alloy, such as an AS resin, an AES resin, or an ASA resin, which has added thereto an engineering plastic or super-engineering plastic (such as polycarbonate, polyamide, or polyester) for the purpose of improving, for example, a heat resistance or a chemical resistance.

The amount of these components in the thermoplastic resin (B) (100% by mass) may be 0 to 50% by mass, and is preferably 0 to 20% by mass because an inexpensive composite material can be obtained.

On the other hand, the amount of a conjugated diene component in the copolymer (C) is 10% by mass or less. Specifically, this means that the amount of a conjugated diene component to the total amount of monomer components in the monomer mixture forming the copolymer (C) is 10% by mass or less.

The conjugated diene component means a monomer having a conjugated diene which has double bonds separated by one single bond, and, for example, there can be mentioned butadiene and isoprene.

When the amount of the conjugated diene component in the copolymer (C) is larger than 10% by mass, the flexural strength is lowered.

With respect to the copolymer (C), particularly, an AS resin is preferred because an inexpensive composite material having excellent mechanical properties can be obtained, and the AS resin especially preferably has a composition (monomer ratio) of acrylonitrile/styrene in the range of from 20/80 to 40/60% by mass.

<Fiber-Reinforced Thermoplastic Resin Composition>

With respect to the amount of the continuous reinforcing fiber (A) and the thermoplastic resin (B) in the fiber-reinforced thermoplastic resin composition of the present invention, the amount of the continuous reinforcing fiber (A) may be 1 to 80% by mass and the amount of thermoplastic resin (B) may be 20 to 99% by mass, based on the mass of the fiber-reinforced thermoplastic resin composition (100% by mass), and, from the viewpoint of the mechanical properties of the fiber-reinforced thermoplastic resin composition, it is preferred that the amount of the continuous reinforcing fiber (A) is 40 to 75% by mass and the amount of the thermoplastic resin (B) is 25 to 60% by mass.

When the amount of the reinforcing fiber is smaller than the above range, the mechanical properties of the resultant fiber-reinforced thermoplastic resin composition are disadvantageously equivalent to those of a light metal or less, and, when the amount of the reinforcing fiber is larger than the above range, the amount of the resin is so small that the sizing action of the matrix resin for the reinforcing fiber causes no function, lowering the mechanical properties.

With respect to the method for producing the fiber-reinforced thermoplastic resin composition, there is no particular limitation, and, for example, there are a method in which a molten resin of the thermoplastic resin (B) is allowed to flow from a T-die of an extruder and joined with the fed continuous fiber sheet so that the continuous fiber sheet is impregnated with the molten resin, a method in which the powder resin is dispersed on a continuous fiber and heat-melted, a method in which the resin is formed into a film and subjected to heat lamination, and a method in which the resin is dissolved in a solvent and then a continuous fiber is impregnated with the resultant solution and dried.

### EXAMPLES

Hereinbelow, the present invention will be described in detail with reference to the following Examples and Comparative Examples. The embodiments can be appropriately changed as long as the effects of the invention can be obtained.

### Example 1

Carbon fiber plain cloth (CFP-3113, manufactured by Arisawa Mfg. Co., Ltd.; mass: 200 g/m²; thickness: 0.2 mm; fiber length in the lengthwise direction: 210 mm; fiber length in the width direction: 300 mm) was impregnated with a varnish comprising 25 parts by mass of an AS resin (“SANREX 290FF”, manufactured by Techno Polymer Co., Ltd. (acrylonitrile/styrene=24/76% by mass)) and 75 parts by mass of methyl ethyl ketone (hereinafter, frequently referred to simply as “MEK”) for 30 seconds, and then dried at 100° C. for one hour to remove the solvent, obtaining a prepreg having the carbon fiber cloth disposed in the AS resin.

6 Pieces of the prepreg material were prepared, and stacked on one another and the resultant material was subjected to press molding using a mold in a flat plate form in the state of being heated to 150° C. under conditions such that the pressing time was 5 minutes and the molding pressure was 1.0 MPa to obtain a continuous fiber-reinforced AS resin sheet.

The obtained sheet was evaluated with respect to the flexural properties in accordance with JIS K 7074, and the results are shown in Table 1.

### Comparative Example 1

Carbon fiber plain cloth (CFP-3113, manufactured by Arisawa Mfg. Co., Ltd.; mass: 200 g/m²; thickness: 0.2 mm; fiber length in the lengthwise direction: 210 mm; fiber length in the width direction: 300 mm) was impregnated with a varnish comprising 25 parts by mass of an ABS resin (“Techno ABS DP611”, manufactured by Techno Polymer Co., Ltd. (acrylonitrile/butadiene/styrene=16/40/44% by mass)) and 75 parts by mass of MEK for 30 seconds, and then dried at 100° C. for one hour to remove the solvent, obtaining a prepreg having the carbon fiber cloth disposed in the ABS resin.

6 Pieces of the prepreg material were prepared, and stacked on one another and the resultant material was subjected to press molding using a mold in a flat plate form in the state of being heated to 150° C. under conditions such that the pressing time was 5 minutes and the molding pressure was 1.0 MPa to obtain a continuous fiber-reinforced ABS resin sheet.

The obtained sheet was evaluated with respect to the flexural properties in accordance with JIS K 7074, and the results are shown in Table 1.

### Comparative Example 2

Carbon fiber plain cloth (CFP-3113, manufactured by Arisawa Mfg. Co., Ltd.; mass: 200 g/m²; thickness: 0.2 mm; fiber length in the lengthwise direction: 210 mm; fiber length in the width direction: 300 mm) was impregnated with a varnish comprising 25 parts by mass of a PS resin (PSJ-Polystyrene, manufactured by PS Japan Corporation) and 75 parts by mass of MEK for 30 seconds, and then dried at 100° C. for one hour to remove the solvent, obtaining a prepreg having the carbon fiber cloth disposed in the PS resin.

6 Pieces of the prepreg material were prepared, and stacked on one another and the resultant material was subjected to press molding using a mold in a flat plate form in the state of being heated to 150° C. under conditions such that the pressing time was 5 minutes and the molding pressure was 1.0 MPa to obtain a continuous fiber-reinforced PS resin sheet.

The obtained sheet was evaluated with respect to the flexural properties in accordance with JIS K 7074, and the results are shown in Table 1.

### Comparative Example 3

Using carbon short fiber-reinforced polyamide (PA)66 (TORAYCA short fiber pellets, 3101T40, manufactured by Toray Industries Inc.; fiber length: 1 mm or less), a flexural test specimen having a thickness of 1 mm, a width of 15 mm, and a length of 60 mm was prepared by injection molding to obtain a short fiber-reinforced PA66 resin sheet. The cylinder temperature was 290° C., and the mold temperature was 80° C. The obtained sheet was evaluated with respect to the flexural properties in accordance with JIS K 7074, and the results are shown in Table 1.

TABLE 1

| | | Compar- | Compar- | Compar- |
|---|---|---|---|---|
| | | ative | ative | ative |
| | Example 1 | Example 1 | Example 2 | Example 3 |
| Reinforcing fiber | Carbon | Carbon | Carbon | Carbon |
| | fiber | fiber | fiber | fiber |
| Continuous fiber (Short | Contin- | Contin- | Contin- | Short |
| fiber < 10 mm ≤ Contin- | uous | uous | uous | fiber |
| uous) | | | | |
| Number of filaments of | 3000 | 3000 | 3000 | — |
| reinforcing fiber thread | | | | |
| (filaments) | | | | |
| Warp density (filaments/ | 12.5 | 12.5 | 12.5 | — |
| 25 mm) | | | | |
| Weft density (filaments/ | 12.5 | 12.5 | 12.5 | — |
| 25 mm) | | | | |
| Basis weight of cloth | 200 | 200 | 200 | — |
| (g/m²) | | | | |
| Cloth construction | Plain cloth | Plain cloth | Plain cloth | — |
| Type of resin | AS | ABS | PS | PA66 |
| Carbon fiber content (% | 47 | 51 | 51 | 51 |
| by mass) | | | | |
| Flexural modulus (GPa) | 41 | 40 | 37 | 21 |
| Flexural strength (MPa) | 310 | 209 | 186 | 313 |

From the above-mentioned Example 1 and Comparative Examples 1 to 3, the following findings are obtained.

When an AS resin is used as a matrix resin in a CFRTP, the flexural strength is improved, as compared to that obtained when a PS resin is used as a matrix resin (Example 1 and Comparative Example 2). The reason for this is considered that the cyano group contained in the AS resin contributes to the improvement of the flexural strength.

When an AS resin is used as a matrix resin in a CFRTP, the flexural strength is improved, as compared to that obtained when an ABS resin is used as a matrix resin (Example 1 and Comparative Example 1). The reason for this is considered that the conjugated diene component contained in the ABS resin lowers the flexural strength of the composite material.

When a continuous fiber is used as a reinforcing fiber in a CFRTP, the modulus is remarkably improved, as compared to that obtained when a short fiber is used as a reinforcing fiber (Example 1 and Comparative Example 3). In the case where a short fiber is used as a reinforcing fiber, even when using, as a matrix resin, PA66 which improves the flexural strength of a composite material, it is difficult to obtain a modulus equivalent to that of a light metal, and, from this, it is apparent that the use of a continuous fiber as a reinforcing fiber is important.

1. A fiber-reinforced thermoplastic resin composition containing (A) a continuous reinforcing fiber and (B) a thermoplastic resin, wherein the thermoplastic resin (B) comprises (C) a copolymer of (c1) a cyano group-containing vinyl monomer and (c2) an aromatic vinyl monomer, wherein the amount of a conjugated diene component in the copolymer (C) (100% by mass) is 10% by mass or less.

2. The fiber-reinforced thermoplastic resin composition according to claim 1, wherein the continuous reinforcing fiber (A) is contained in an amount of 1 to 80% by mass and the thermoplastic resin (B) is contained in an amount of 20 to 99% by mass, based on the mass of the fiber-reinforced thermoplastic resin composition (100% by mass).

3. The fiber-reinforced thermoplastic resin composition according to claim 1, wherein the continuous reinforcing fiber (A) has an average fiber length of 10 mm or more.

4. The fiber-reinforced thermoplastic resin composition according to claim 1, wherein the continuous reinforcing fiber contains any one selected from the group consisting of a carbon fiber, a glass fiber, and an aramid fiber.

5. The fiber-reinforced thermoplastic resin composition according to claim 1, wherein the amount of the copolymer (C) in the thermoplastic resin (B) (100% by mass) is 50 to 100% by mass.

6. The fiber-reinforced thermoplastic resin composition according to claim 1, wherein the amount of the cyano group-containing vinyl monomer (c1) in the copolymer (C) (100% by mass) is 15 to 45% by mass and the amount of the aromatic vinyl monomer (c2) in the copolymer (C) (100% by mass) is 55 to 85% by mass.

7. The fiber-reinforced thermoplastic resin composition according to claim 1, wherein the copolymer (C) is a copolymer consisting of the cyano group-containing vinyl monomer (c1) and the aromatic vinyl monomer (c2).

8. The fiber-reinforced thermoplastic resin composition according to claim 1, wherein the copolymer (C) is acrylonitrile-styrene.

9. A shaped article using the fiber-reinforced thermoplastic resin composition according to claim 1.

10. The shaped article according to claim 9, which has a maximum flexural strength of 300 MPa or more.
